(19) United States
(12) Patent Application Publication
(10) Pub. No.: US 2013/0124280 A1
(43) Pub. Date: May 16, 2013

(54) REAL TIME REDEMPTION TRACKING SYSTEM

(71) Applicant: Tansel Yilmaz, Long Beach, CA (US)

(72) Inventor: Tansel Yilmaz, Long Beach, CA (US)

(21) Appl. No.: 13/464,940

(22) Filed: May 4, 2012

Related U.S. Application Data
(60) Provisional application No. 61/482,600, filed on May 4, 2011.

(51) Int. Cl. G06Q 30/02

(52) U.S. Cl. 705/14.13

(57) ABSTRACT

A marketing system is disclosed comprising a merchant server including means for providing a vendor website; a point of sale terminal in communication with the merchant server, the point of sale terminal for conducting a retail transaction with a customer; a tracking server in communication with the merchant server, the tracking server for acquiring customer statistics and providing the customer statistics to the merchant server; and an internet-ready device in communication with a marketing system application disposed in the tracking server, the internet-ready device for utilizing a token received in the retail transaction.

### CROSS REFERENCE TO RELATED APPLICATION

The present Application is related to Provisional Patent Application entitled “Real Time Redemption Tracking System,” filed 4 May 2011 and assigned filing No. 61/482,600, and is incorporated herein by reference in its entirety.

### FIELD OF THE INVENTION

This invention relates generally to a commercial marketing system and, more specifically, to a method and apparatus for real-time or non-real-time or eventually up-to-date, location-based tracking of the redemption of offers made to consumers.

### BRIEF DESCRIPTION OF THE DRAWINGS

FIG. 1 is a functional illustration of a real-time or non-real-time or eventually up-to-date, location-based marketing system, in accordance with an aspect of the present invention; and

FIG. 2 is a flow diagram illustrating operation of the marketing system of FIG. 1.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention.

The disclosed marketing system provides for offer/coupon redemption tracking by making use of a software token generator or a hardware security token to issue and track transaction points earned by a customer. The merchant may be required to push a physical button to obtain a token from a hardware token generator, or to “push” a virtual button from a software token generator. Alternatively, the merchant may be required to enter a coupon code into the hardware token generator to obtain a token.

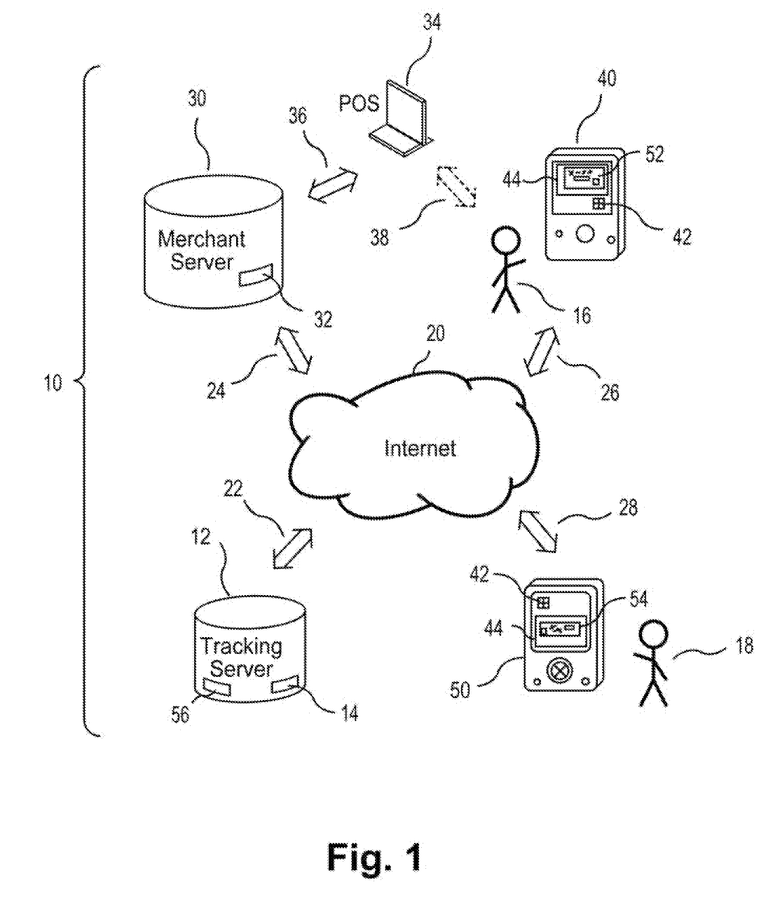

There is shown in FIG. 1 a marketing system 10, in accordance with the present invention. The marketing system 10 operates in accordance with a marketing system application 14 resident in a tracking server 12. The marketing system application 14 may be in communication with a network, such as the Internet 20, via a tracking communication link 22. Similarly, a merchant server 30, operated by a retailer, a merchant, or a vendor may be in communication with the Internet 20 via a merchant communication link 24.

The merchant server 30 may further support a vendor website 32 that communicates with the marketing system application 14, as described in greater detail below. It should be understood that, although the marketing system 10 comprises a real-time system, the operations of the marketing system 10, as described in greater detail below, may also function in non real time, or in “eventually p to date” mode, by using token generators in customer transactions.

The merchant server 30 may also be in communication with an electronic point-of-sale (POS) terminal 34 via local merchant communication link 36. In an exemplary embodiment, the POS terminal 34 may be used in a retail commerce establishment (not shown) operated by the retailer, offering real-time deals and related information for dining, entertainment, and other retail resources. A local, potential customer 16 may execute a retail transaction 38 with the merchant by visiting the retail facility of the merchant, as described in greater detail below.

The customer 16 preferably has access to a Internet-ready device 40, such as a PDA, a mobile phone, a cellular phone, a Tablet, a personal computer, or a SmartPhone, for example. In an exemplary embodiment, the Internet-ready device 40 may include an Internet device application 42 which functions to communicate with the vendor website 32 and with the marketing system application 14 via a customer communication link 16, as described in greater detail below.

The Internet-ready device 40 may thus access a vendor webpage 44, which enables the customer 16 to view and consider the offers and information provided by the merchant, such as a coupon 52. In this manner, the customer 16 may avail himself of merchant offers for real-time deals, entertainment, dining, and other services, essentially “anytime and anywhere.” The customer 16 thus has available a self-serve space to find out what is going on in his neighborhood or community. It should be understood that, for the purpose of the present disclosure, the terms “vendor,” “retailer,” and “merchant” may be used interchangeably,

A vendor webpage 46 may be similarly accessed by a remote potential customer 18 using a Internet-ready device 50. The Internet-ready device 50 may also function to access the Internet 20, via a remote customer communication link 28. In an exemplary embodiment, the customer 18 may reside or work in a geographical location different from that of the local customer 16. Accordingly, the vendor webpage 46 may a coupon 54 that is different from the coupon 52 displayed on the vendor webpage 44. In general, the vendor webpage 46 comprises offers and information directed to the geographical location of the remote customer 18, to display information and offers attractive to the customer 18.

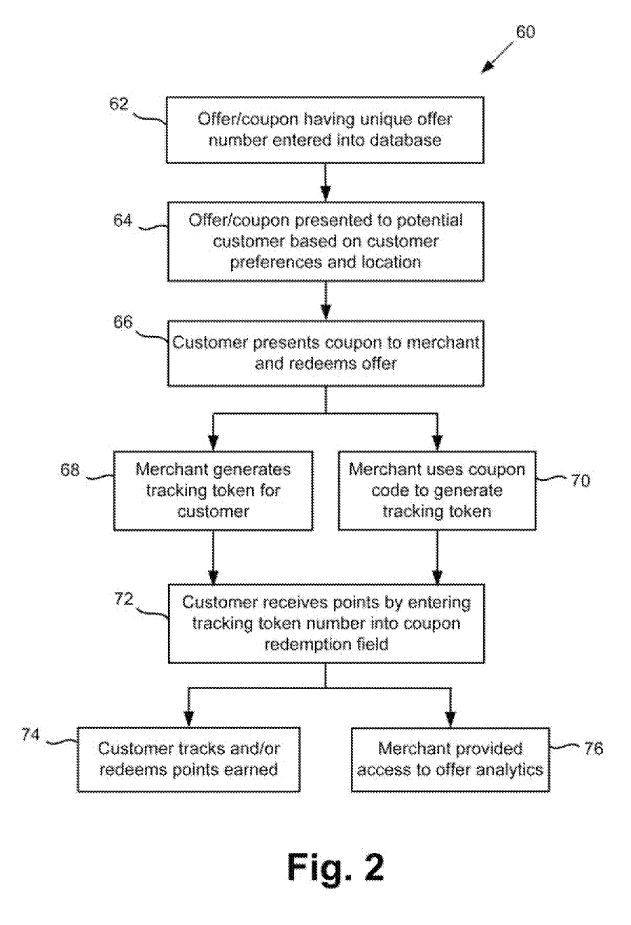

The innovative method executed with the marketing system 10 can be described with reference to a flow diagram 60, shown in FIG. 2. The offer, or coupon 52, having a unique offer number, may be generated via the vendor website 32. The unique offer number may be entered into the merchant server 30 by the merchant or by an administrator of the tracking server 12, at step 62.

The coupon 52 may be provided to the customer 16 based on one or more preferences, such as age, location, gender, at step 64. It can be appreciated that, although preference details may be optional with the customer 16, the more information that can be provided by the customer 16, the better an offer and associated coupon can be customized or tailored to the preferences of the customer 16.

Accordingly, the customer 18 may then patronize a retail location to redeem the offer issued by the merchant, by presenting the coupon 52 on his Internet-ready device 40 to the merchant, at step 66. The merchant may subsequently generate a unique tracking token for the customer 16, at step 68. This may be accomplished, for example, using a two-factor dynamic password generating key device such as the battery-powered two factor token OTP1001 available from Shenzhen Justtide Technology Co., Ltd., of China. The token, typically an alphanumeric key, may be generated via the Internet device application 42 in the Internet-ready device 40, or through an API interface in the vendor website 32 or at the marketing system application 14. The unique, identifying code can be used as a scan code, or a human-readable code. In an exemplary embodiment, the coupon 52 may be posted at selected places online, or may be available in printed form in magazines and newspapers.

In an alternative embodiment, that can be used with printed coupons, the merchant may use a code associated with the coupon 52 to generate a unique tracking token for the customer 16, at step 70. This may be accomplished, for example, using a three-factor dynamic password generating key device such as the three factor token OTP2000 available from Shenzhen Justtide Technology Co., Ltd. It should be understood that the merchant can use either battery-powered token generator described above without requiring access to the Internet 20. Accordingly, the customer 16 may enter his token in real-time, immediately upon obtaining the token from the merchant, or may enter his token at a later time, that is, in non-real time.

As can be appreciated by one skilled in the art, the coupon code may be encrypted via the public key of a cryptographic algorithm system such as used via Pretty Good Privacy (PGP) or Secure Socket Layer (SSL) by the merchant, and later decrypted by the tracking server 12 using the private key of the merchant. If the hardware token generator does not have a keyboard, the hardware token generator will only track and validate the merchant. However if the hardware token generator does include a keyboard, then the hardware token generator can encrypt the coupon code and track each individual coupon or offer. In comparison, a software token generator may always encrypt the coupon into the token and can, therefore, track the merchant and the coupon.

It should he understood that a two-factor hardware token may comprise a code which identifies the merchant only. A three-factor hardware token generator, which includes a keyboard, and a software token generator, may both identify the merchant as well as the coupon code. The customer 16 can enter the token into his mobile communication device 40, or any other Internet-ready web device, such as a personal computer or a tablet, for example, to redeem the coupon 52. The marketing system 10 may function to measure such real-time or “eventually updated” consumer offers and redemption activity. The marketing system 10 may further function to present the merchant with statistics from the tracking statistics database 56 in the tracking server 12.

At step 72, the customer 16 may enter the token number into the tracking statistics database 56 by accessing a coupon redemption field in the Internet device application 42, and thereby receives points. However, if the customer 16 is not known to the marketing system 10, the customer 16 may not earn points for the transaction.

At step 74, the customer 16 can track earned points in real time by accessing the vendor web site 32 via the customer communication device 40. The customer 16 can redeem his earned points using a method similar to that used for credit card points or frequent flyer points, for example. At step 76, the merchant may be given real-time access to a detailed report outlining offer performance and related analytics, stored and updated in the tracking server 12. The merchant may have an option to receive the reports on a daily, weekly, or monthly basis, for example.

It can be appreciated by one skilled in the relevant art that an exemplary embodiment of the marketing system 10 may function without a requirement that software be installed at manufacturer side or business point-of-sale (POS) side. The marketing system 10 comprises the hardware or software token which, preferably, can generate and display a code with the merchant pressing a real or virtual button. The merchant thus creates the token, and provides the token to the customer 16.

It can be appreciated to one skilled in the art that some of the advantages provided by the marketing system 10 includes; (i) no software for the customer to install, to use, or to learn if the customer uses the hardware token; (ii) no clearinghouse connection or hardware and maintenance are needed; and (iii) relatively inexpensive components used in the marketing system 10. The software token has an only one-time development cost and can be replicated at very little cost. The corresponding software can be installed on a merchant's desktop machine, or in a POS system, or on a mobile device as an API. Alternatively, the merchant can use a web token generator by logging into an account in the marketing system 10.

It can be further appreciated to one skilled in the art that the marketing system 10 also makes it easier for the merchant or vendor to collect and track data, as well as making it easier for offerings, redeeming activity, and administering the marketing system 10. The marketing system 10 may provide the merchant with an inexpensive unique token generator and a website where the merchant can publish offers. The token generator, a unique vendor number, and an offer number are all correlated with one another. The customer 16, who redeems the offer using the marketing system application 14, the application platform, and the vendor website 32, essentially “closes the circle.”

The marketing system 10 thus offers the advantage that detailed information can be tracked inexpensively an unobtrusively with minimal distraction to the participants. In particular, the marketing system 10 can also track the vendor offerings, the customers, the times of customer transactions, the transaction locations, and most or all possible demographic data. Further, as described above, the merchant may track his customer transactions without requiring an Internet connection. That is, making use of the marketing system 10 in non-real time.

it is to be understood that the description herein is exemplary of the invention only and is intended to provide an overview for the understanding of the nature and character of the invention, The accompanying drawings are included to provide a further understanding of various features and embodiments of the method and apparatus of the invention which, together with their description serve to explain the principles and operation of the invention. Thus, while the invention has been described with reference to particular embodiments, it will be understood that the present invention is by no means limited to the particular constructions and methods herein disclosed and/or shown in the drawings.

What is claimed is:

1. A marketing system comprising:
a merchant server including means for providing a vendor website;
a point of sale terminal in communication with said merchant server, said point of sale terminal for conducting a retail transaction with a customer;
a tracking server in communication with said merchant server, said tracking server for acquiring customer statistics and providing said customer statistics to said merchant server; and
an internet-ready device in communication with a marketing system application disposed in said tracking server, said internet-ready device for utilizing a token received in said retail transaction.
